(19) United States
(12) Patent Application Publication
(10) Pub. No.: US 2012/0325019 A1
(43) Pub. Date: Dec. 27, 2012

(54) FORCE SENSING DEVICE AND FORCE SENSING SYSTEM

(75) Inventors: Yio-Wha Shau, Taipei City (TW); Arvin Huang-Te Li, Chiayi City (TW); Gaung-Hui Gu, Checheng Township (TW); Bai-Kuang Hwang, Hsinchu City (TW); Jen-Chieh Lin, Hsinchu City (TW)

(73) Assignee: INDUSTRIAL TECHNOLOGY RESEARCH INSTITUTE, HSINCHU (TW)

(21) Appl. No.: 13/279,664

(22) Filed: Oct. 24, 2011

(30) Foreign Application Priority Data
Jun. 21, 2011 (TW) 100121712

(51) Int. Cl. G01L 1/10; G01L 1/12

(52) U.S. Cl. 73/862.59; 73/862.69

(57) ABSTRACT

A force sensing device and a force sensing system are provided. The force sensing device comprises at least one magnetic material layer and a force sensing layer which can move with respect to each other. The force sensing layer comprises two sensing elements. The first sensing element, disposed along a first axis of the magnetic material layer, generates a sensing signal varying with a first lateral force applied on the force sensing device. The first lateral force enables the first sensing element to move relatively with respect to the magnetic material layer along the first axis. The second sensing element, disposed along a second axis of the magnetic material layer, generates a sensing signal varying with a second lateral force applied on the force sensing device. The second lateral force enables the second sensing element to move relatively with respect to the magnetic material layer along the second axis.

This application claims the benefit of Taiwan application Serial No. 100121712, filed Jun. 21, 2011, the disclosure of which is incorporated by reference herein in its entirety.

### BACKGROUND

1. Technical Field

The disclosed embodiments relate in general to applications of force sensing, and more particularly to a force sensing device and a force sensing system using the same.

2. Description of the Related Art

Many types of sensing devices for measuring the force applied on/by a user's foot are already available in the market. Most of the sensing devices are used for measuring the force applied on/by a user's foot when the user stands on the earth or a certain surface. For example, the sensing devices measure a maximum force applied on/by the user's foot, a total force applied on/by the user's foot, or a force applied on/by a particular part of the user's foot. Such sensing devices usually have an appearance of a flat platform. When a user stands on such platform, the sensing device will measure the force applied on/by his or her foot. Such type of sensing device is usually used in laboratories or hospitals.

The sensing device for foot force can be implemented by using different types of force sensing elements. In a practical implementation, the force sensing element can be realized for example by a resistive sensor, a capacitive sensor, a pneumatic sensor, a hydraulic fluid activated sensor, or a strain gauge sensor. Each type of force sensing element can convert a mechanic or external force into an electrical signal, which can further be converted into a measurement of the force.

However, most conventional force sensing devices are focused on measuring the normal force (referred as the force along the gravity direction). Since the foot force is related to the gravity direction, conventional force sensing devices usually measure the static force applied on/by a user's foot when the user stands or remains immobilized. Thus, conventional force sensing devices are found limited in applications.

### SUMMARY

The disclosure is directed to a force sensing device and a force sensing system using the same, in which the principles of electromagnetic conversion are based on measuring a lateral force applied on the sensing device. In addition, other pressure-sensitive materials, such as piezoelectric material, can be used for measuring a normal force (for example, a perpendicular force or a vertical force) applied on the sensing device. In this way, the force sensing device achieves three-dimensional force measurement.

According to one embodiment, a force sensing device is provided. The force sensing device comprises at least one magnetic material layer and a force sensing layer which can move with respect to each other. The force sensing layer comprises two sensing elements. The first sensing element, disposed along a first axis of the magnetic material layer, generates a sensing signal which varies with a first lateral force applied on the force sensing device. The first lateral force enables the first sensing element to move relatively with respect to the magnetic material layer along the first axis for generating an electric signal representing the first lateral force. The second sensing element, disposed along a second axis of the magnetic material layer, generates a sensing signal which varies with a second lateral force applied on the force sensing device. The second lateral force enables the second sensing element to move relatively with respect to the magnetic material layer along the second axis for generating an electric signal representing the second lateral force.

According to another embodiment, a force sensing system is provided. The force sensing system comprises at least one force sensing device, an analog signal amplifying and filtering unit, a control unit, and an output unit. Each force sensing device comprises at least one magnetic material layer and a force sensing layer. The force sensing layer is moveable relative to the magnetic material layer. The force sensing layer comprises two sensing elements. The first sensing element, disposed along a first axis of the magnetic material layer, generates a first sensing signal which varies with a first lateral force applied on the force sensing device. The first lateral force enables the first sensing element to move relatively with respect to the magnetic material layer along the first axis for generating an electric signal representing the first lateral force. The second sensing element, disposed along a second axis of the magnetic material layer, generates a second sensing signal which varies with a second lateral force applied on the force sensing device. The second lateral force enables the second sensing element to move relatively with respect to the magnetic material layer along the second axis for generating an electric signal representing the second lateral force. The analog signal amplifying and filtering unit of the force sensing system of the disclosure is coupled to the force sensing device for amplifying and filtering the generated signals. The control unit is coupled to the analog signal amplifying and filtering unit for converting the amplified and filtered signals, and collecting the converted signal. The output unit is coupled to the control unit for receiving the collected signals, and outputting the received signals.

### BRIEF DESCRIPTION OF THE DRAWINGS

FIG. 1 is a schematic diagram of a force sensing device based on the principles of electromagnetic conversion according to an embodiment;

FIG. 2 is a top view of the structure of a force sensing device according to an embodiment;

FIG. 3 is a top view of the structure of a force sensing device according to an alternative embodiment;

FIG. 4 is a top view of the structure of a force sensing device according to an alternative embodiment;

FIG. 5 is a side view of the structure of a force sensing device according to an alternative embodiment;

FIG. 6 is a side view of the structure of a force sensing device according to an alternative embodiment;

FIG. 7 is a side view of the structure of a force sensing device according to an alternative embodiment;

FIG. 8A is a block diagram of an example of a force sensing system according to an alternative embodiment;

FIG. 8B is a circuit diagram of an example of an analog signal amplifying and filtering unit of the force sensing system of FIG. 8A;

FIG. 9 is a block diagram of another example of a force sensing system according to an alternative embodiment;

FIGS. 10A and 10B are schematic diagrams of an example of practical implementation of the force sensing system of FIG. 9; and

FIG. 11 is a flowchart of an example of the operating process of a force sensing system.

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

### DETAILED DESCRIPTION

A number of embodiments are disclosed below for elaborating the disclosure. However, the embodiments of the disclosure are for detailed descriptions, and the disclosure is not limited thereto. Furthermore, secondary elements are omitted in the accompanying diagrams of the embodiments for highlighting the technical features of the disclosure.

According to exemplary embodiments of the disclosure, a force sensing device and a force sensing system using the same are disclosed. The force sensing device and the force sensing system using the same base the principles of electromagnetic conversion on measuring a lateral force applied on the sensing device. In some embodiments, other pressure-sensitive materials, such as piezoelectric material, can be used for measuring a normal force applied on the sensing device. In this way, the force sensing device can achieve three-dimensional force measurement, and can become useful in versatile applications.

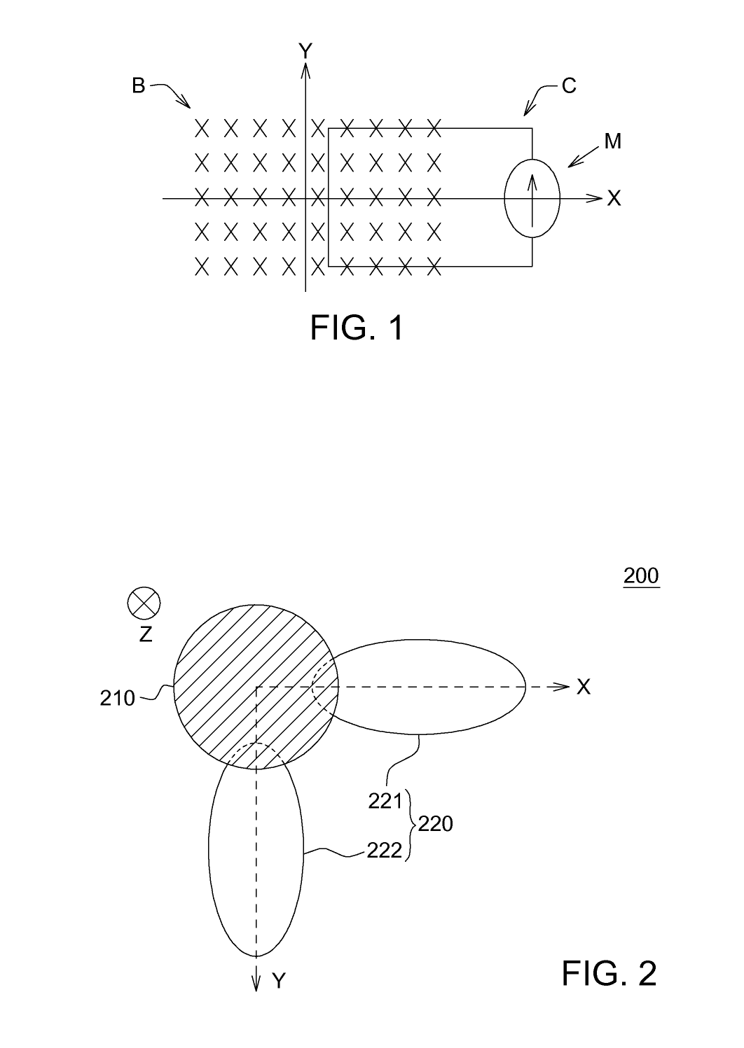

Referring to FIG. 1, a schematic diagram of a force sensing device based on the principles of electromagnetic conversion according to an embodiment is shown. Magnetic field B has a surface defined by the first axis X and the second axis Y. According to Faraday's law of electromagnetic induction, the relative motion between the circuit and the magnetic field causes changes to current or voltage. When the conductor C moves, within the magnetic field B, with respect to the magnet (not illustrated) or the other way round, the magnetic field and the magnetic flux variation of the conductor will induce an electromotive force. If the conductor C is connected to a detector M such as an ampere meter or a voltage meter, there will be a current flowing through the conductor C. The polarity or the current direction of the electromotive force is related to the direction of the relative motion between the conductor C and the magnetic field B. The electromotive force or the generation of the current indicates that the energy of mechanic motion can be converted into electrical energy and can be used as a basis for force sensing.

In the disclosure, the first axis, the second axis and the third axis can be realized as the axes of the Cartesian coordinate system in which every two axes are perpendicular to each other or the axes of a generalized coordinate system.

In an embodiment of the force sensing device and the force sensing system using the same, according to the principles of electromagnetic conversion, a lateral force causes a relative motion between the magnetic material layer and the sensing element layer, which induces an electrical signal related to the relationship between lateral force and displacement. Thus, the magnitude of the lateral force or the displacement can be obtained from the electrical signal. Exemplary embodiments are disclosed below for detailed descriptions.

In one embodiment, the force sensing device comprises at least one magnetic material layer and a force sensing layer which can move with respect to each other. The force sensing layer comprises two sensing elements. The first sensing element, disposed along a first axis of the magnetic material layer, generates a sensing signal which varies with a first lateral force applied on the force sensing device. The first lateral force enables the first sensing element to move relatively with respect to the magnetic material layer along the first axis for generating an electric signal representing the first lateral force. The second sensing element, disposed along a second axis of the magnetic material layer, generates a sensing signal which varies with a second lateral force applied on the force sensing device. The second lateral force enables the second sensing element to move relatively with respect to the magnetic material layer along the second axis for generating an electric signal representing the second lateral force.

Referring to FIG. 2, a top view of the structure of a force sensing device according to one embodiment is shown. The force sensing device 200 comprises a magnetic material layer 210 and a force sensing layer 220. The magnetic material layer 210 of the force sensing device 200 is placed on a surface which is defined by the first axis X and the second axis Y. The force sensing device 200 can measure a sensing signal which represents a first lateral force applied on the force sensing device 200 in the first axis X. Alternatively, the force sensing device 200 can measure a sensing signal which represents a second lateral force applied on the force sensing device 200 in the second axis Y. The lateral force is for example a force that causes a relative motion between the magnetic material layer 210 and the force sensing layer 220, thus inducing an electric signal indicative of such force.

The magnetic material layer 210 of the present embodiment uses a permanent magnet. The magnetism line of the magnetic material layer 210 is emitted along the normal direction of the surface of the magnetic material layer 210. For example, the magnetism line is emitted along the axis Z. In the present example, the normal direction is illustrated as a direction out of the paper, but the disclosure is not limited thereto.

The magnetic material layer 210 and the force sensing layer 220 can be movably connected with each other. For example, one of the magnetic material layer 210 and the force sensing layer 220 is fixed and the other one is movable, or both are movable and can move with respect to each other.

In the present embodiment, the force sensing layer 220 comprises a first sensing element 221 and a second sensing element 222, wherein the first sensing element 221 and the second sensing element 222 are formed by coils.

The first sensing element 221 can be disposed along the first axis X of the surface of the magnetic material layer 210. The first sensing element 221 can generate a first sensing signal which varies with the first lateral force applied on the force sensing device 200. The first lateral force can enable the first sensing element 221 to move relatively with respect to the magnetic material layer 210 on the first axis X for generating a signal representing the first lateral force.

The second sensing element 222 can be disposed along the second axis Y of the surface of the magnetic material layer 210. The second sensing element 222 can generate a second sensing signal which varies with the second lateral force applied on the force sensing device 200. The second lateral force can enable the second sensing element 222 to move relatively with respect to the magnetic material layer 210 on the second axis Y for generating a signal representing the second lateral force.

In the present embodiment of the force sensing layer 220, the first sensing element 221 and the second sensing element 222 are disposed on the same side of the magnetic material layer 210. Thus, the relative motion between the magnetic material layer 210 and the force sensing layer 220 can cause changes to the magnetic flux and induce an electrical signal, so that the force sensing device 200 can achieve lateral force measurement.

For example, suppose the force sensing layer 220 is fixed. As the magnetic material layer 210 moves along the first axis X or the second axis Y, the relative motion between the magnetic material layer 210 and the force sensing layer 220 makes the first sensing element 221 or 222 of the force sensing layer 220 sense the change in the magnetic field and accordingly generates a sensing signal of an induced current or an induced voltage. From the relationship between induced current or voltage signal and the applied force, the lateral force and displacement can be obtained.

For another example, suppose the magnetic material layer 210 is fixed. As the force sensing layer 220 moves along the first axis X or the second axis Y, the relative motion between the magnetic material layer 210 and the force sensing layer 220 makes the first sensing element 221 or 222 of the force sensing layer 220 sense the change in the magnetic field and accordingly generates a sensing signal of an induced current or an induced voltage. From the relationship between induced current or voltage signals and the applied force, the lateral force and displacement can be obtained.

The force sensing layer of the force sensing device and the force sensing system can comprise two sensing elements each including wires, conductors and coils. Examples of the coils comprise the coils that are single-circled, multi-circled, single-layered, multi-layered, connected in parallel or serial and can form any looped structure, or any planar or three-dimensional coils that can form any shapes.

Further, the magnetic material layer of the force sensing device and the force sensing system can for example comprise a permanent magnet, an inductance magnet or a magnetic metal, and can be formed by materials such as iron (Fe), cobalt (Co), nickel (Ni), cobalt nickel chromium alloy (Co—Ni—Cr), cobalt chromium tantalum alloy (Co—Cr—Ta), cobalt chromium platinum alloy (Co—Cr—Pt), cobalt chromium platinum boron alloy (Co—Cr—Pt—B), iron terbium alloy (TbFe), gadolinium cobalt alloy (GdCo), dysprosium nickel alloy (DyNi), neodymium iron boron alloy (NdFeB) or a combination thereof. The appearance of the magnetic material layer can be flat type or thin-film type. The magnetic material layer comprises at least one magnetic material layer realized for example by a single-layered or a multi-layered stack structure.

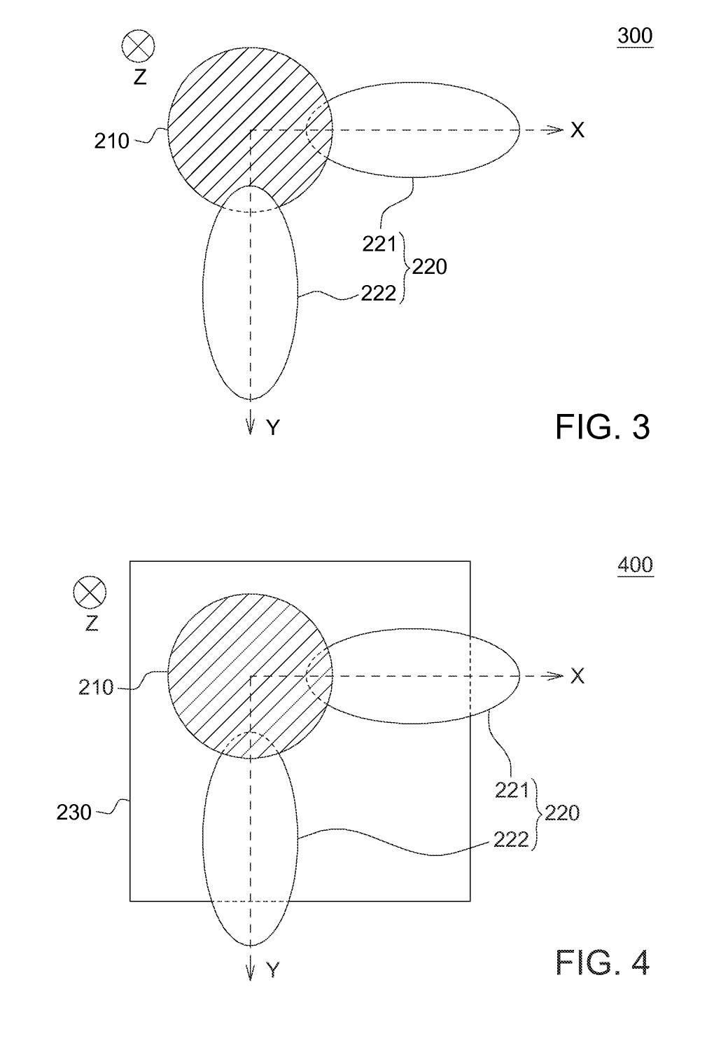

Referring to FIG. 3, a top view of the structure of a force sensing device according to another one embodiment is shown.

The force sensing device 300 of the embodiment is different from the force sensing device 200 of the first embodiment in that the first sensing element 221 and the second sensing element 222 of the force sensing device 300 of the second embodiment are located on different sides of the magnetic material layer 210. As illustrated in FIG. 3, the first sensing element 221 is located underneath the magnetic material layer 210, and the second sensing element 222 is located above the magnetic material layer 210.

In the exemplified embodiments, the first sensing element 221 and the second sensing element 222 are located on the same side or different sides of the same magnetic material layer 210. However, this disclosure is not limited thereto. Any embodiments are feasible as long as the first sensing element 221 and the second sensing element 222 are capable of sensing changes in the magnetic field of the magnetic material layer 210 when receiving a force.

In the present embodiment, the relative motion between the magnetic material layer 210 and the force sensing layer 220 will cause changes to the magnetic flux and induce an electrical signal. Then, the lateral force and displacement can be obtained from the relationship of the induced current or voltage signal and the applied force, so that the force sensing device 300 can achieve lateral force measurement.

Referring to FIG. 4, a top view of the structure of a force sensing device according to an alternative embodiment is shown.

The force sensing device 400 of the third embodiment is different from the force sensing device 200 of the embodiment in that the force sensing device 400 of the embodiment further comprises another magnetic material layer 230. The magnetic material layer 230 and the magnetic material layer 210 are opposite to each other and are arranged in a parallel or non-parallel manner. The force sensing layer 220 is disposed between the magnetic material layer 210 and the magnetic material layer 230.

In the present embodiment, there are a relative motion between the magnetic material layer 210 and the force sensing layer 220, a relative motion between the magnetic material layer 230 and the force sensing layer 220, a relative motion between the magnetic material layer 210 and the magnetic material layer 230, and a relative motion among the magnetic material layer 210 the magnetic material layer 230 and the force sensing layer 220, any of which can cause changes to the magnetic flux and induce an electrical signal. Then, the lateral force and displacement can be obtained from the relationship of the induced current or voltage signal and the applied force, so that the force sensing device 400 can achieve lateral force measurement.

In alternative embodiments, the force sensing device further comprises a third sensing element. The third sensing element can use another pressure-sensitive material, such as piezoelectric material, for measuring the normal force applied on the sensing device. The third sensing element, disposed along a third axis of the surface of the magnetic material layer, generates a third sensing signal which varies with the normal force applied on the force sensing device in the third axis. In the disclosure, the first axis, the second axis and the third axis can be realized as the axes of the Cartesian coordinate system in which every two axes are perpendicular to each other or the axes of a generalized coordinate system.

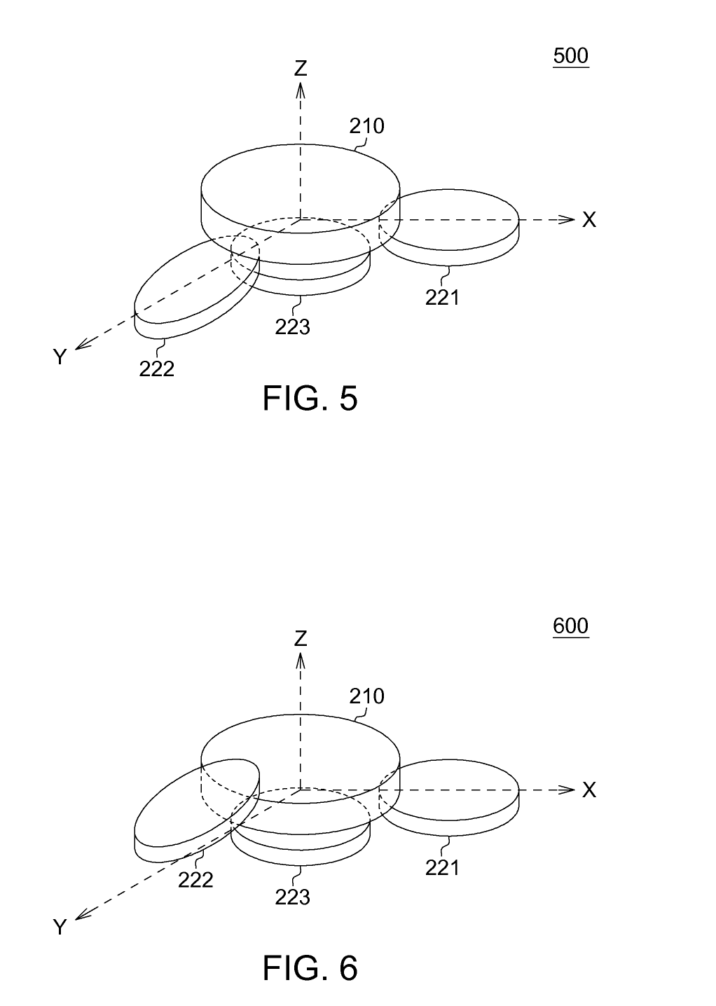

Referring to FIG. 5, a side view of the structure of a force sensing device according to one embodiment is shown.

The force sensing device 500 of the embodiment is different from the force sensing device 200 of the embodiment in that the force sensing device 500 can be used for measuring not only lateral force but also normal force. The so called “normal force” refers to a force along the third axis Z. In the present example, the normal force refers to a force along the normal direction of the surface of the magnetic material layer 210 such as the direction of the third axis Z.

As indicated in FIG. 5, the force sensing device 500 further comprises a third sensing element 223. The third sensing element 223 is disposed along a third axis of the surface of the magnetic material layer Z. The third sensing element 223 generates a third sensing signal which varies with the normal force applied on the force sensing device 500 along the third axis Z.

In the present embodiment, the third sensing element 223 can be formed by a thin-film type of piezoelectric material, such as a material implementing the conversion between mechanic energy and electrical energy according to the piezoelectric effect. The piezoelectric effect can be understood as an electromechanical interaction between the mechanical and the electrical state in crystalline materials. The piezoelectric effect is a reversible process in that materials exhibiting the direct piezoelectric effect (the internal generation of electrical charge resulting from an applied mechanical force) also exhibit the reverse piezoelectric effect (the internal generation of a mechanical force resulting from an applied electrical field).

Thus, when the force sensing device 500 receives a normal force along the third axis Z, the third sensing element 223 will be deformed and induced an electrical signal. Then, the lateral force and displacement can be obtained from the relationship of the induced current or voltage signal and the applied force, so that the force sensing device 500 can achieve lateral force measurement.

Referring to FIG. 6, a side view of the structure of a force sensing device according to another one embodiment is shown.

The force sensing device 600 of the embodiment is different from the force sensing device 500 of the embodiment in that the first sensing element 221 and the second sensing element 222 of the force sensing device 600 of the embodiment are located on different sides of the magnetic material layer 210. As illustrated in FIG. 6, the first sensing element 221 is located underneath the magnetic material layer 210 and the second sensing element 222 is located above the magnetic material layer 210.

In the exemplified embodiments, the first sensing element 221 and the second sensing element 222 are located on the same side or different sides of the layer of the magnetic material layer 210. However, this disclosure is not limited thereto. Any embodiments are feasible as long as the first sensing element 221 and the second sensing element 222 are capable of sensing changes in the magnetic field of the magnetic material layer 210 when receiving a force.

In the present embodiment, the relative motion between the magnetic material layer 210 and the force sensing layer 220 will cause changes to the magnetic flux and induce an electrical signal. Then, the lateral force and displacement can be obtained from the relationship of the induced current or voltage signal and the applied force, so that the force sensing device 600 can achieve lateral force measure.

Furthermore, in some embodiments of the disclosure, the third sensing element of the force sensing device and system can comprise a pressure-sensitive material, such as piezoelectric material. For example, the third sensing element can be formed by ceramic materials of barium titanate (BaTiO3) and lead zirconate titanate (PZT), single-crystal materials of quartz (crystal), tourmaline, Rochelle salt (or potassium sodium tartrate), tantalates, and niobate, or thin-film materials of zinc oxide (ZnO).

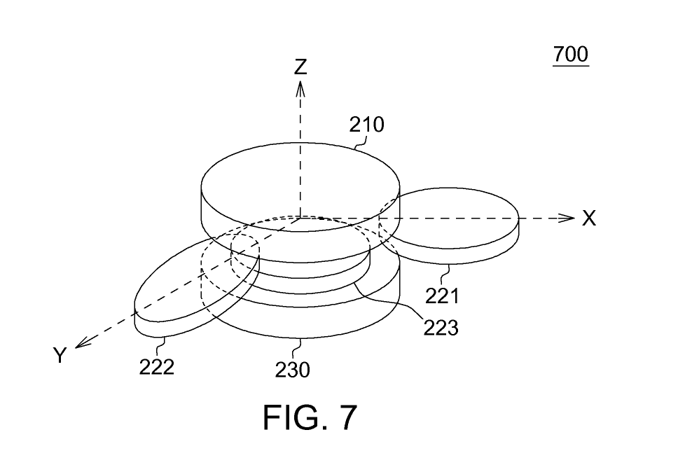

Referring to FIG. 7, a side view of the structure of a force sensing device according to an alternative embodiment is shown.

The force sensing device 700 of the embodiment is different from the force sensing device 500 of the embodiment in that the force sensing device 700 of the embodiment further comprises another magnetic material layer 230. The magnetic material layer 230 and the magnetic material layer 210 are opposite to each other in a parallel or non-parallel manner. The force sensing layer 220 is disposed between the magnetic material layer 210 and the magnetic material layer 230.

In the present embodiment, there are a relative motion between the magnetic material layer 210 and the force sensing layer 220, a relative motion between the magnetic material layer 230 and the force sensing layer 220, a relative motion between the magnetic material layer 210 and the magnetic material layer 230, and a relative motion among the magnetic material layer 210, the magnetic material layer 230 and the force sensing layer 220, any of which can cause changes to the magnetic flux and induce an electrical signal. Then, the lateral force and displacement can be obtained from the relationship of the induced current or voltage signal and the applied force, so that the force sensing device 700 can achieve lateral force measurement.

In some embodiments disclosed above, the force sensing device can use a magnetic element to measure a force according to the relationship between the induced current or voltage signal and the applied force, thus realizing the measurement of a lateral force. In addition, in other embodiments disclosed above, the force sensing device can further use other pressure-sensitive materials (such as piezoelectric material) to measure a pressure force, thus realizing the measurement of a normal force. In comparison to convention methods which measure a static force applied by a user's foot when the user stands or remains immobilized, the embodiments can achieve lateral force measurement, so that the force sensing device can become useful in more versatile applications.

According to another embodiment, a force sensing system is provided. The force sensing system comprises at least one force sensing device, an analog signal amplifying and filtering unit, a control unit, and an output unit. Each force sensing device comprises at least one magnetic material layer and a force sensing layer. The force sensing layer is moveable relative to the magnetic material layer. The force sensing layer comprises two sensing elements. The first sensing element, disposed along a first axis of the magnetic material layer, generates a first sensing signal which varies with a first lateral force applied on the force sensing device. The first lateral force enables the first sensing element to move relatively with respect to the magnetic material layer along the first axis for generating an electric signal representing the first lateral force. The second sensing element, disposed along a second axis of the magnetic material layer, generates a second sensing signal which varies with a second lateral force applied on the force sensing device. The second lateral force enables the second sensing element to move relatively with respect to the magnetic material layer along the second axis for generating an electric signal representing the second lateral force.

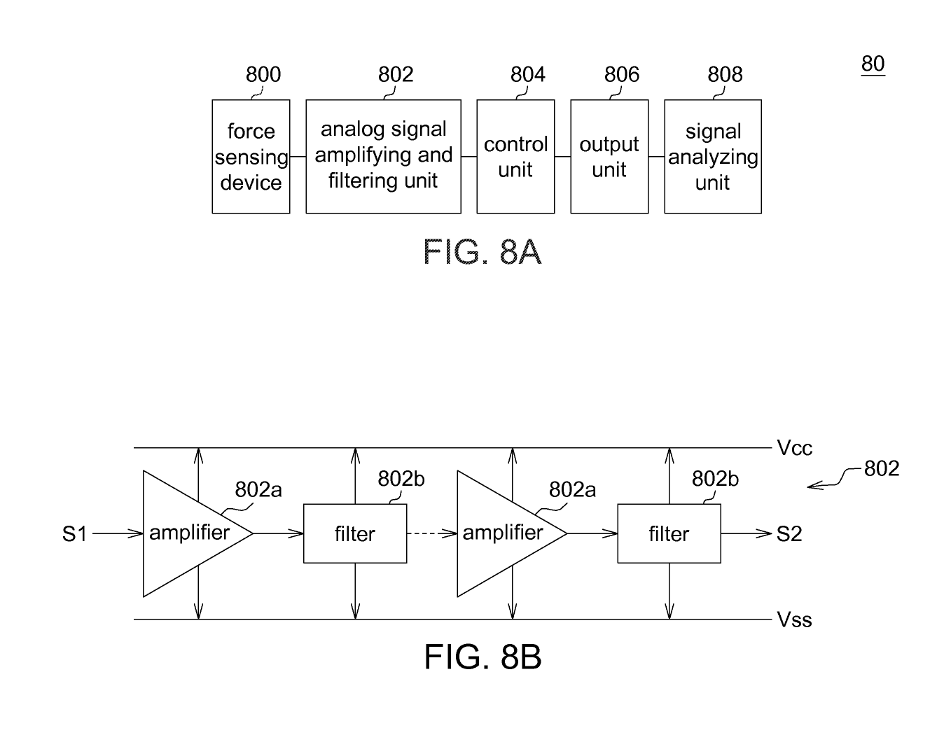

Referring to FIG. 8A, a block diagram of an example of a force sensing system according to an embodiment is shown. The force sensing system 80 comprises a force sensing device 800, an analog signal amplifying and filtering unit 802, a control unit 804, and an output unit 806. In the present embodiment, the force sensing system 80 uses a single force sensing device 800, and can thus be regarded as a unit cell force sensing system.

The force sensing device 800 can be realized as the force sensing device disclosed in any of the abovementioned embodiments. If the force sensing device 800 is realized as the force sensing devices 200, 300, 400 of the embodiments, then the force sensing device 800 can generate two sets of sensing signals related to lateral forces. If the force sensing device 800 is realized as the force sensing devices 500, 600, 700 of the embodiments, then the force sensing device 800 can generate two sets of sensing signals related to lateral forces and one set of sensing signals related to a normal force.

The analog signal amplifying and filtering unit 802 is coupled to the force sensing device 800. The analog signal amplifying and filtering unit 802 is a front-end processing circuit for amplifying and filtering the sensing signals generated by the force sensing device 800. Referring to FIG. 8B, a circuit diagram of an example of an analog signal amplifying and filtering unit of the force sensing system of FIG. 8A is shown. In this example, the analog signal amplifying and filtering unit 802 comprises multi-stage amplifiers 802a and several filters 802b, wherein the amplifiers 802a and the filters 802b are connected between two power rails Vcc and Vss for amplifying a small signal S1 into a gained or amplified signal S2. In practical implementation, stages of the amplifiers 802a, gains of the amplifiers 802a, or the number of filters can be designed to meet actual needs and different requirements.

The control unit 804 is coupled to the analog signal amplifying and filtering unit 802. The control unit 804 converts and collects the amplified and filtered signals. For example, the control unit 804 can detect current or voltage values from the sensing signals, and then convert the voltage or the current values into corresponding force values denoting the magnitude of the force. The conversion of the values can be obtained from a look up table of voltage and force, a look up table of current and force. Alternatively, formula derivation, or experimental experience and trial and error can also be used. In practical implementation, the control unit 804 can be realized by a micro control unit (MCU).

The output unit 806 is coupled to the control unit 804. The output unit 806 receives the collected sensing signals and outputting the received signals. The output unit 806 is for example a communication circuit. In some practical examples, the output unit 806 can be realized by a wireless communication circuit based on such as Bluetooth, ultra-red light, radio frequency identification (RFID) technology, or other wireless communication technology. In some other practical examples, the output unit 806 can be realized by a wired communication circuit for outputting the signal via a transmission wire.

In the embodiment, the force sensing system 80 further comprises a signal analyzing unit 808 as indicated in FIG. 8A. The signal analyzing unit 808 is coupled to the output unit 806, and the two units are connected via wireless transmission or wired transmission. The signal analyzing unit 808 is for receiving the outputted sensing signals and analyzing the received signals.

In some practical examples, the signal analyzing unit 808 further comprises a display unit, such as a display, for displaying parameters of the sensing signal for the user to view. Examples of the parameters comprise the magnitude of the received or applied forces, displacement, amplitude, frequency or phase.

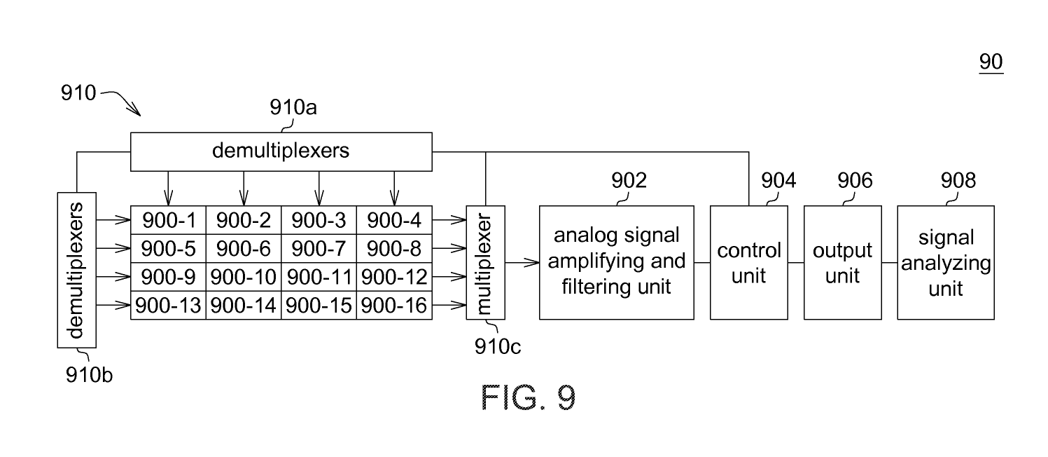

Referring to FIG. 9, a block diagram of another example of a force sensing system according to an embodiment is shown. Different from the force sensing system 80 of FIG. 8A, the multi-cell force sensing system 90 of FIG. 9 uses a plurality of force sensing devices 900-1-900-16, and can thus be regarded as a multi-cell force sensing system.

In the embodiment, the multi-cell force sensing system 90 further comprises a scan unit 910 as indicated in FIG. 9. The scan unit 910 is controlled by the control unit 904 to select one or several force sensing devices from these force sensing devices 900-1-900-16 in a time division multiplexing manner. The scan unit 910 then obtains sensing signals from the selected force sensing devices. In the present embodiment, the scan unit 910 comprises two de-multiplexers 910a, 910b, and a multiplexer 910c for selecting a force sensing device at a time. In other examples, the scan unit 910 can select two or more than two force sensing devices at a time.

In the multi-cell force sensing system 90, the sensing units can be distributed in different areas, so as to realize regional or local force measurement. Thus, the multi-cell force sensing system 90 can become useful in more versatile applications.

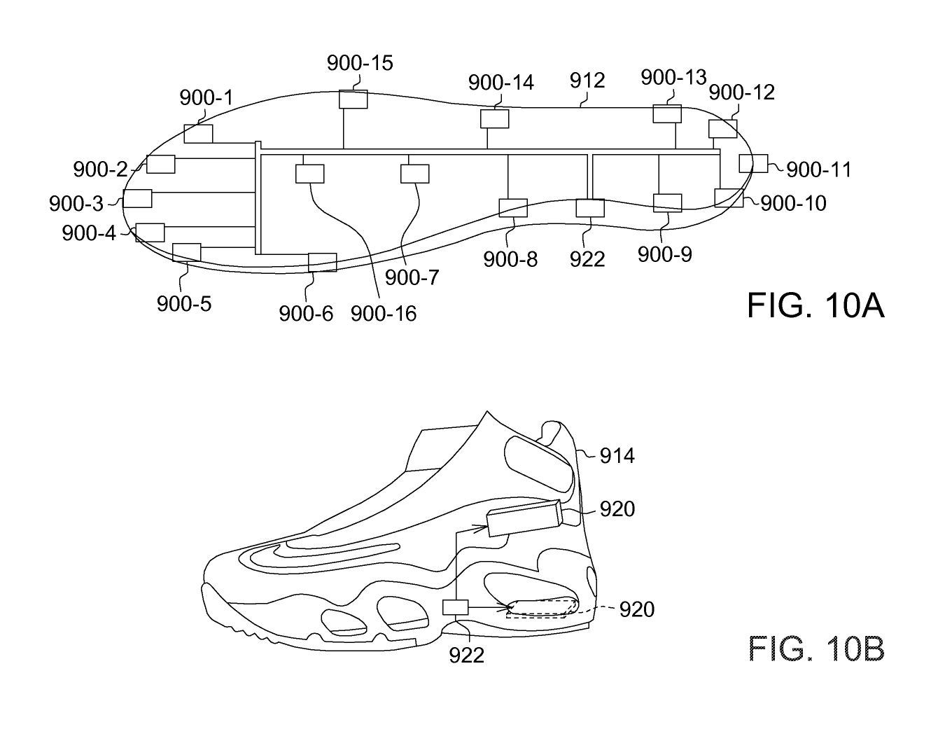

Referring to FIGS. 10A and 10B, schematic diagrams of an example of practical implementation of the force sensing system of FIG. 9 are respectively shown. As indicated in FIG. 10A, the multi-cell force sensing system 90 can be used in an insole 912 for measuring the force applied on/by a user's foot. The force sensing devices 900-1-900-16 are distributed over various positions of the insole 912 such as the edges, the middle portion, the front portion or the rear portion of the insole 912. Thus, each of the force sensing devices 900-1-900-16 can operate independently to sense the state of the force applied on/by the current position. Thus, the multi-cell force sensing system 90 can analyze and integrate the force applied on/by the current positions to obtain the total force applied on/by the insole 912, the force applied on/by a local region of the insole 912, or the distribution of the force applied on/by the insole 912.

Since the multi-cell force sensing system 90 of FIG. 10A is exemplified as being used in the insole 912, other signal processing elements such as the analog signal amplifying and filtering unit 902, the control unit 904, and the output unit 906 can be realized and designed to prevent the operation of the force sensing devices 900-1-900-16 from being affected. For example, the units 902, 904, 906 can be realized as a signal processing circuits 920, which are connected to the force sensing devices 900-1-900-16 via a connection end 922. The signal processing circuit 920 can be embedded in the lining, the bottom or the heel portion of a shoe 914, or is hanged or attached on a lateral surface of the shoe 914 as indicated in FIG. 10B. However, the disclosure is not limited to the above exemplifications, and any positions of the signal processing circuit 920 not affecting the operation of the force sensing devices 900-1-900-16 are feasible embodiments.

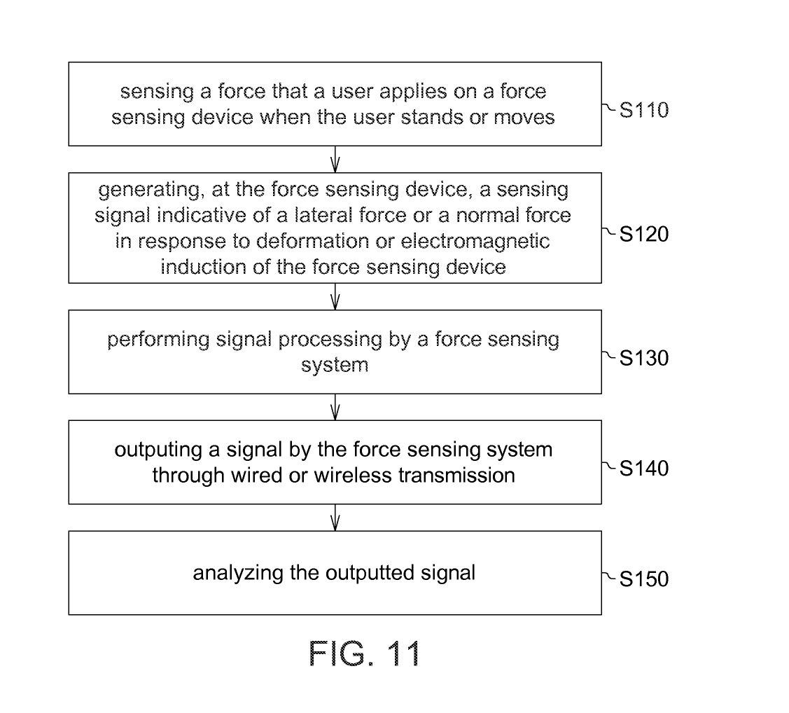

Referring to FIG. 11, a flowchart of an example of the operating process of a force sensing system is shown. As indicated in step S110, the force sensing device senses a force that a user applies on the force sensing device when the user stands or moves. As indicated in step S120, the force sensing device generates a sensing signal indicative of a lateral force or a normal force in response to deformation or electromagnetic induction of the force sensing device. As indicated in step S130, signal processing is performed by the force sensing system. As indicated in step S140, a signal is outputted by the force sensing system through wired or wireless transmission. As indicated in step S150, the outputted signal is analyzed.

According to aforementioned embodiments of the force sensing device and system, the principles of electromagnetic conversion are based on inducing a current or voltage sensing signal. From the relationship between the sensing signal and the applied force, a lateral force and a corresponding displacement can be obtained. In addition, there are embodiments of the force sensing device and system where other pressure-sensitive materials, such as piezoelectric material, are used for measuring a normal force applied on the device. As such, the force sensing device and system can be used to measure two lateral forces while selectively to measure one normal force, thus achieving three-dimensional force measurement, and becoming useful in more versatile applications. For example, the force sensing device of the disclosure can be used in a force sensing system for measuring three-dimensional force of a user's foot. Practical applications comprise rehabilitation for patents with peripheral nerve diseases, posture correction exercises for athletes, and detecting or warning that prevents children or the elderly from falling and getting injured.

It will be apparent to those skilled in the art that various modifications and variations can be made to the disclosed embodiments. It is intended that the specification and examples be considered as exemplary only, with a true scope of the disclosure being indicated by the following claims and their equivalents.

What is claimed is:

1. A force sensing device, comprising:
at least one magnetic material layer; and
at least one force sensing layer which is moveable relative to the magnetic material layer, wherein the force sensing layer comprises:
a first sensing element disposed along a first axis of the magnetic material layer, wherein the first sensing element is moveable relative to the magnetic material layer for generating a signal representing a first lateral force; and
a second sensing element disposed along a second axis of the magnetic material layer, wherein the second sensing element is moveable relative to the magnetic material layer for generating another signal representing a second lateral force.

2. The force sensing device according to claim 1, wherein the force sensing layer further comprises:
a third sensing element disposed along a third axis of the magnetic material layer, wherein the third sensing element generates a normal force when being pressed.

3. The force sensing device according to claim 1, further comprising:
another magnetic material layer, wherein the force sensing layer is disposed inside or outside the two magnetic material layers.

4. The force sensing device according to claim 3, wherein the force sensing layer further comprises:
a third sensing element disposed along a third axis of the magnetic material layer, wherein the third sensing element generates a normal force when being pressed.

5. The force sensing device according to claim 1, wherein the first sensing element and the second sensing element are located on the same side or different sides of the same magnetic material layer.

6. The force sensing device according to claim 1, wherein the magnetic material layer is a single-layered or a multi-layered stack structure.

7. The force sensing device according to claim 1, wherein the first sensing element and the second sensing element comprise wires, conductors, and coils.

8. The force sensing device according to claim 1, further comprising:
a detector for detecting voltage variation or current variation induced when the first lateral force or the second lateral force causes a change in magnetic field.

9. The force sensing device according to claim 2, wherein the third sensing element comprises a piezoelectric material.

10. The force sensing device according to claim 9, wherein the piezoelectric material comprises ceramic materials such as barium titanate (BaTiO₃), lead zirconate titanate (PZT), single crystal materials of quartz (crystal), tourmaline, Rochelle salt (or potassium sodium tartrate), tantalates, and niobate, or thin-film materials of zinc oxide (ZnO).

11. The force sensing device according to claim 2, wherein the normal force is a measurement obtained from voltage variation or current variation induced when the third sensing element is pressed.

12. The force sensing device according to claim 1, wherein the magnetic material layer comprises a permanent magnet, an inductance magnet or a magnetic metal.

13. The force sensing device according to claim 12, wherein the magnetic material layer comprises iron (Fe), cobalt (Co), nickel (Ni), cobalt nickel chromium alloy (Co—Ni—Cr), cobalt chromium tantalum alloy (Co—Cr—Ta), cobalt chromium platinum alloy (Co—Cr—Pt), cobalt chromium platinum boron alloy (Co—Cr—Pt—B), iron terbium alloy (TbFe), gadolinium cobalt alloy (GdCo), dysprosium nickel alloy (DyNi), neodymium iron boron alloy (NdFeB) or a combination thereof.

14. A force sensing system, comprising:
at least one force sensing device, wherein the force sensing device comprises:
at least one magnetic material layer; and
at least one force sensing layer, which is moveable relative to the magnetic material layer, wherein the force sensing layer comprises:
a first sensing element disposed along a first axis of the magnetic material layer, wherein the first sensing element is moveable relative to the magnetic material layer for generating a signal representing a first lateral force; and
a second sensing element disposed along a second axis of the magnetic material layer, wherein the second sensing element is moveable relative to the magnetic material layer for generating a signal representing a second lateral force;
an analog signal amplifying and filtering unit coupled to the force sensing device for amplifying and filtering the generated signals;
a control unit coupled to the analog signal amplifying and filtering unit for converting and collecting the amplified and filtered signals; and
an output unit coupled to the control unit for receiving the collected signals and outputting the received signals.

15. The force sensing system according to claim 14, wherein the force sensing layer further comprises:
a third sensing element disposed along a third axis of the magnetic material layer, wherein the third sensing element generates a normal force when being pressed.

16. The force sensing system according to claim 14, wherein the first sensing element and the second sensing element comprises wires, conductors, and coils.

17. The force sensing system according to claim 15, wherein the third sensing element comprises a piezoelectric material.

18. The force sensing system according to claim 14, wherein the sensing signal is a voltage signal or a current signal.

19. The force sensing system according to claim 14, further comprising:
a signal analyzing unit coupled to the output unit for receiving and analyzing the outputted signals.

20. The force sensing system according to claim 19, wherein the signal analyzing unit comprises a display unit for displaying analysis result.
